(19) United States
(12) Patent Application Publication
(10) Pub. No.: US 2016/0356486 A1
(43) Pub. Date: Dec. 8, 2016

(54) Foldable Easel with a Lighting System

(71) Applicants: Stacie L. Garlieb, Phoenix, AZ (US); Mark Garlieb, Phoenix, AZ (US)

(72) Inventors: Stacie L. Garlieb, Phoenix, AZ (US); Mark Garlieb, Phoenix, AZ (US)

(21) Appl. No.: 15/159,580

(22) Filed: May 19, 2016

Related U.S. Application Data
(60) Provisional application No. 62/163,869, filed on May 19, 2015.

(51) Int. Cl. F21V 33/00; F21V 23/02; F21V 21/32; A47B 97/08; F21V 23/06

(52) U.S. Cl. CPC F21V 33/0012; A47B 97/08; F21V 23/06; F21V 21/32; F21V 23/02

(57) ABSTRACT

A foldable easel with a lighting system includes a foldable frame, a left light fixture, and a right light fixture. The foldable frame includes a rear central rail, a right front rail, a left front rail, a plate, and a cross brace assembly. Three rails are hingedly connected to each other with the plate and the cross brace assembly that is centrally positioned to the foldable frame. The plate and the cross brace assembly foldably secure the rear central rail, the left front rail, and the right front rail. The left and right light fixtures are detachably mounted to the foldable frame. The left and right light fixtures are powered through a power supply system and selectively controlled by a user to direct illumination towards a painting or portrait that is held within the foldable frame.

The current application claims benefit of U.S. Provisional Patent application Ser. No. 62/163,869 filed on May 19, 2015.

### FIELD OF THE INVENTION

The present invention relates generally an easel. More specifically, the present invention is a pre-wired foldable easel with a lighting system that includes an on/off switch and a dimmer switch.

### BACKGROUND OF THE INVENTION

Traditionally artists' easels are just a simple stand used to hold a canvas at an elevated and angled position so that an artist can easily paint. Traditional easels do not offer a lighting mechanism for the artist to use when the painting area lacks sufficient lighting. Generally, artists have to use separate lighting stands to light up the painting area or the canvas when working in low light environments. This causes the painting area to be cluttered especially when the artist is working in a studio with other artists. When the amount of clutter increases around an easel, the chances of tipping over the easel or a light stand also increases. Additionally, when the artist is working on a detailed section, the artist needs the respective area to be clearly visible. Ideally, the artist would like to focus additional lighting to the working area so that the respective area can be clearly visible. This usually requires the artist to obtain a light stand that has a focused lighting system thus allowing the artist to move the focused lighting system in areas that requires additional lighting. When moving the focused lighting system to a specific areas of the canvas, the process is inconvenient for the artist as they have to reach over to the light stand that are usually positioned next to or behind the artist. Additionally, this also increases the probability of knocking over the light stand or any of the artist's supplies.

It is therefore an object of the present invention to provide a foldable easel that combats the aforementioned issues by integrating a lighting system directly onto the foldable easel. As a result, the present invention eliminates clutter and gives the artist the ease of moving the lighting system to any specific area of the canvas. In addition to holding a canvas for an artist to work on, the present invention also provides the displaying apparatus with gallery quality lighting for an artwork and visual designs to be showcased in homes, businesses and galleries.

### BRIEF DESCRIPTION OF THE DRAWINGS

FIG. 1 is a front perspective view of the present invention.

FIG. 2 is a top view of the present invention showing the first lateral joint, the second lateral joint, the rear joint, and the respective rotational axis.

FIG. 3 is a rear perspective view of the present invention.

FIG. 4 is a detail view of the present invention showing the connection between the plate and the left front rail, the right front rail, and the rear central rail.

FIG. 5 is a detail view of the present invention showing the no-slip foot member within the left front rail.

FIG. 6 is a detail view of the present invention showing the no-slip foot member within the right front rail.

FIG. 7 is a detail view of the present invention showing the no-slip foot member within the rear central rail.

FIG. 8 is a front perspective view of the preferred embodiment of the foldable frame showing the plurality of platforms.

FIG. 9 is a front perspective view of the first alternative embodiment of the foldable frame showing the plurality of upper platforms.

FIG. 10 is a front perspective view of the second alternative embodiment of the foldable frame showing the plurality of lower platforms.

FIG. 11 is a rear view of the present invention showing the connection of the left light fixture and the right light fixture.

FIG. 12 is a basic schematic diagram showing the AC electrical system within the present invention.

FIG. 13 is a basic schematic diagram showing the DC electrical system within the present invention.

### DETAIL DESCRIPTIONS OF THE INVENTION

All illustrations of the drawings are for the purpose of describing selected versions of the present invention and are not intended to limit the scope of the present invention.

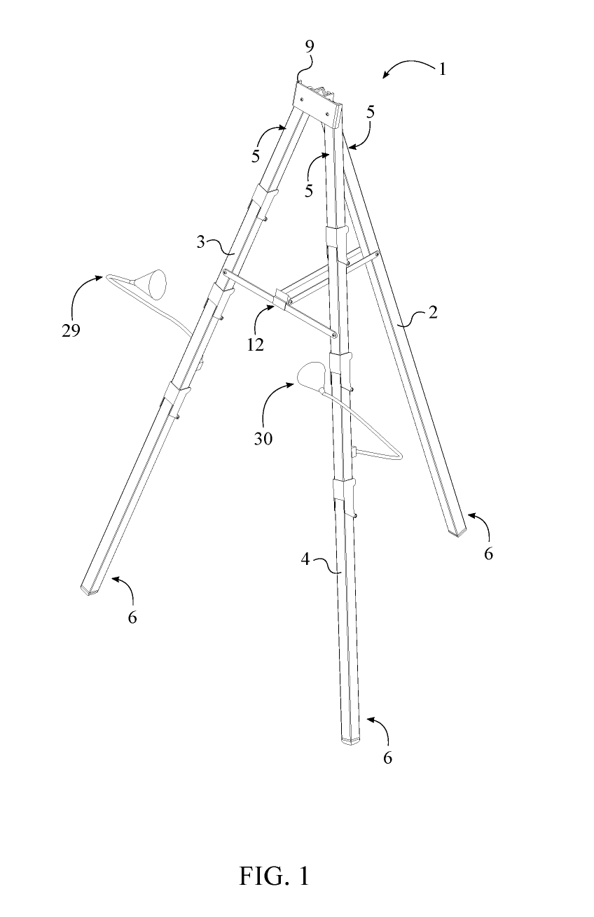

The present invention is a foldable and portable easel with a lighting system. The present invention provides solution for limited wall space and provides multiple levels of placement for an artwork while providing essential illumination for an artwork that is placed within. As a result of the aforementioned benefits, the present invention is able to provide an improved and efficient easel compare to existing easels. The present invention comprises a foldable frame 1, a power supply system 34, a left light fixture 29, and a right light fixture 30 as shown in FIG. 1. In reference to the general configuration of the present invention, the foldable frame 1 that functions as the stand or the base of the present invention comprises a rear central rail 2, a left front rail 3, a right front rail 4, a plate 9, and a cross brace assembly 12. A proximal end 5 of the rear central rail 2, the left front rail 3, and the right front rail 4 are each hingedly connected to the plate 9 in order to form the overall shape of the foldable frame 1. The cross brace assembly 12 that stabilize foldable frame 1 is hingedly connected to the rear central rail 2, the left front rail 3, and the right front rail 4. Additionally, the cross brace assembly 12 is positioned in between the plate 9 and a distal end 6 of the rear central rail 2, the left front rail 3, and the right front rail 4 to maintain the overall shape and structural support of the foldable frame 1. The left light fixture 29 is detachably mounted to the left front rail 3. The right light fixture 30 is detachably mounted to the right front rail 4. The left light fixture 29 and the right light fixture 30 are able to provide illumination to an artwork that is placed within the foldable frame 1 as the left light fixture 29 and the right light fixture 30 are electrically connected to the power supply system 34.

The foldable frame 1 provides the overall shape of the present invention, wherein components connections between the rear central rail 2, the left front rail 3, the right front rail 4, and the plate 9 allow the present invention to switch between an unfolded configuration and a folded configuration. More specifically, the unfolded configuration allows the user to place and support an artwork within the foldable frame 1. In particular, the distal end 6 of the rear central rail 2, the left front rail 3, and the right front rail 4 are positioned further apart from each other forming a tetrahedron pyramid shape. The folded configuration allows the user to store the present invention with minimum amount of storage space as the distal end 6 of the rear central rail 2, the left front rail 3, and the right front rail 4 are positioned adjacent to each other forming an elongated rectangular shape. Additionally, the height of the rear central rail 2, the left front rail 3, and the right front rail 4 also determine the overall height of the foldable frame 1.

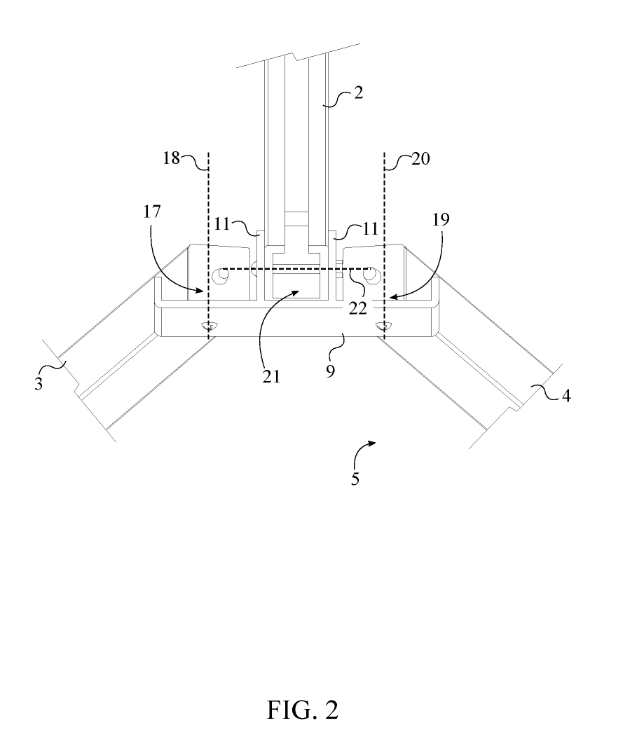

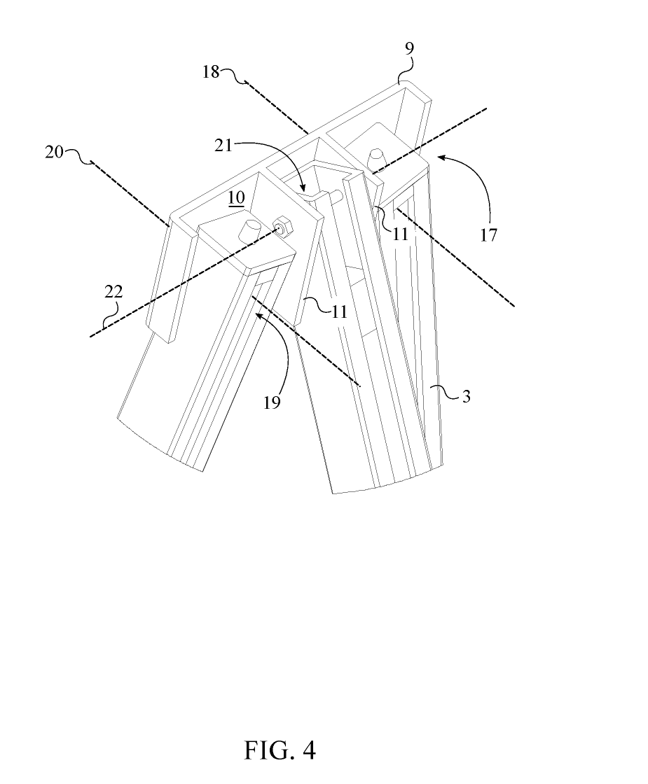

In reference to FIG. 2 and FIG. 4, the plate 9 functions as a connecting member within the present invention as the left front rail 3 and the right front rail 4 are connected to a rear surface 10 of the plate 9. More specifically, the proximal end 5 of the left front rail 3 is hingedly mounted to the rear surface 10 of the plate 9 by a left lateral joint 17. Similarly, the proximal end 5 of the right front rail 4 is hingedly mounted to the rear surface 10 of the plate 9 by a right lateral joint 19. The left lateral joint 17 and the right lateral joint 19 are oppositely positioned of each other across the plate 9 in such a way that a rotational axis 18 of the left lateral joint 17 is oriented parallel to a rotational axis 20 of the right lateral joint 19. In order to form the tetrahedron pyramid shape, the plate 9 comprises a pair of perpendicular supports 11 that are vertically positioned along the rear surface 10 of the plate 9. In reference to FIG. 2, the proximal end 5 of the rear central rail 2 is hingedly mounted to the pair of perpendicular supports 11 by a rear joint 21 that is positioned in between the left lateral joint 17 and the right lateral joint 19. However, a rotational axis 22 of the rear joint 21 is oriented perpendicular to the rotational axis 18 of the left lateral joint 17 and the rotational axis 20 of the right lateral joint 19. As a result, the left front rail 3 and the right front rail 4 are able to radially extend outward about the left lateral joint 17 and the right lateral joint 19 respectively. The rear central rail 2 can radially extend backward about the rear joint 21, resulting the tetrahedron pyramid shape.

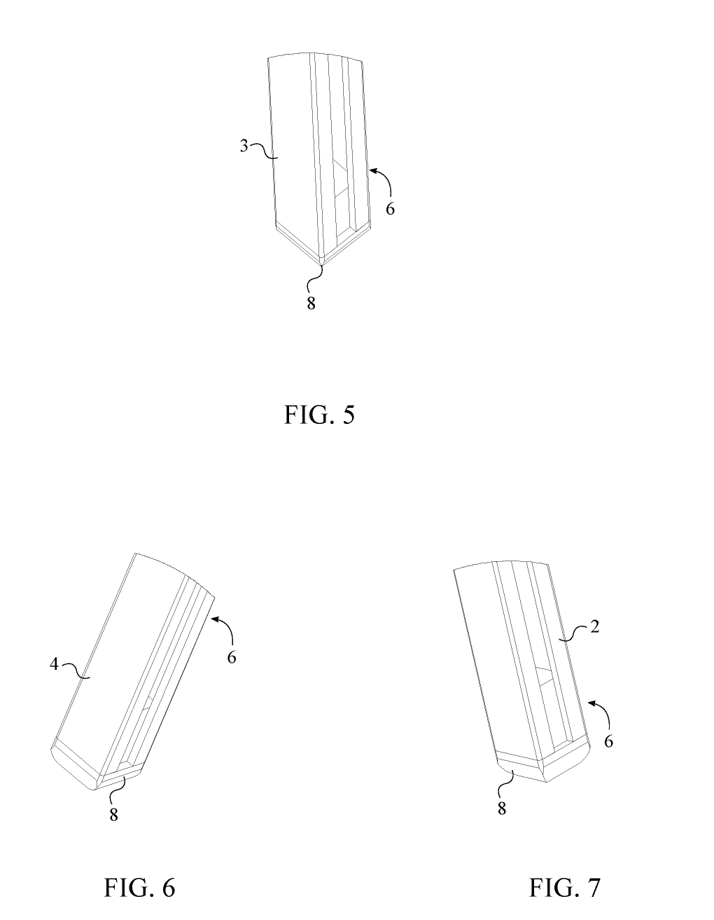

In reference to FIG. 5-7, the foldable frame 1 further comprises a plurality of no-slip foot members 8 to improve the traction between the foldable frame 1 and the resting surface that the present invention is placed upon. More specifically, each no-slip foot member 8 is adjacently connected to the distal end 6 of the rear central rail 2, the left front rail 3, and the right front rail 4. The plurality of no-slip foot members 8 ensures that the foldable frame 1 does not slip or move laterally on the resting surface.

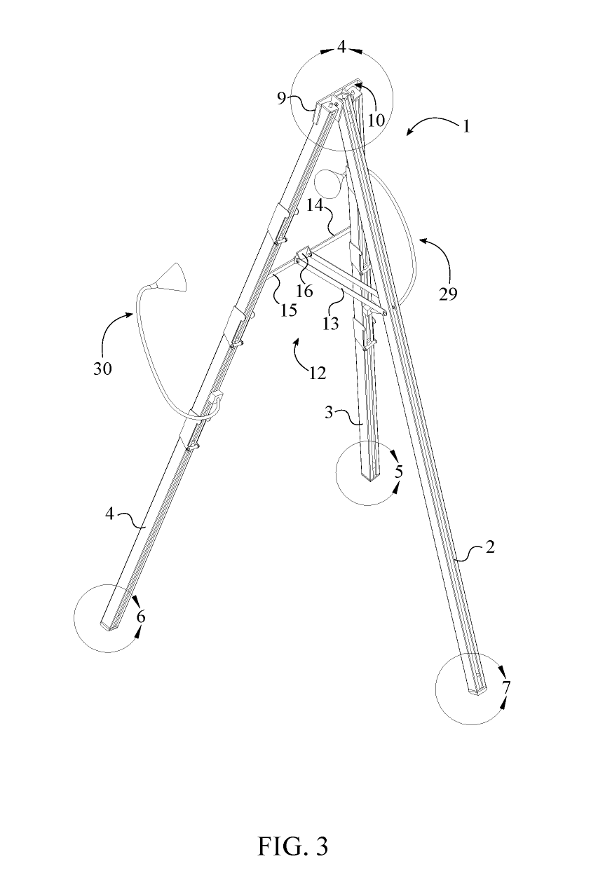

The cross brace assembly 12 limits how far the rear central rail 2, the left front rail 3, and the right front rail 4 can extend about the respective rotational axis without compromising the structural integrity of the present invention. In reference to FIG. 3, the cross brace assembly 12 comprises a rear brace 13, a left front brace 14, a right front brace 15, and a mounting hub 16. The rear brace 13, the left front brace 14, and the right front brace 15 are interconnected to each other by the mounting hub 16 so that the foldable frame 1 can switch between the folded configuration and the unfolded configuration, without putting excessive pressure on the left lateral joint 17, the right lateral joint 19, and the rear joint 21. More specifically, the mounting hub 16 and the left front rail 3 are hingedly mounted to each other by the left front brace 14. The mounting hub 16 and the right front rail 4 are hingedly mounted to each other by the right front brace 15. In order to aligned with the left front rail 3 and the right front rail 4, the left front brace 14 and the right front brace 15 are oppositely positioned of each other about the mounting hub 16. The mounting hub 16 and the rear central rail 2 are hingedly mounted to each other by the rear brace 13 as the rear brace 13 is perpendicularly positioned of the left front brace 14 and the right front brace 15 when the present invention is at the unfolded configuration. Since the rear brace 13, the left front brace 14, the right front brace 15, and the mounting hub 16 are made of rigid structural material, the cross brace assembly 12 is able to regulate the distance traveled by the rear central rail 2, the left front rail 3, and the right front rail 4 from the folded configuration to the unfolded configuration and vice versa.

The present invention further comprises at least one pair of platforms so that an artwork can be placed upon the pair of platforms and rested against the left front rail 3 and the right front rail 4. In other words, the pair of platforms provide a surface on which an artwork may rest upon. However, the present invention is not limited to only one pair of platforms and the number of platform pairs can differ upon different embodiments and user requirements.

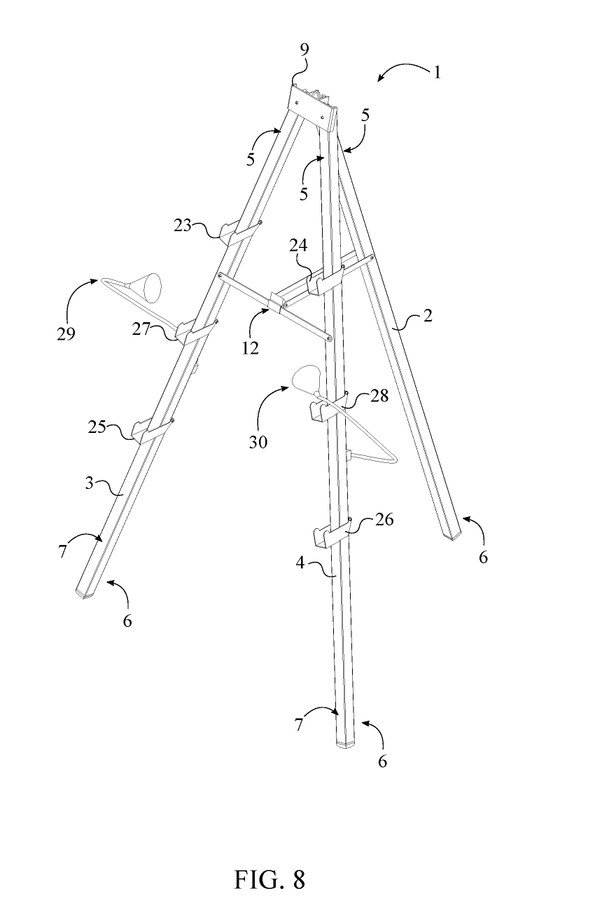

In reference to a preferred embodiment of the foldable frame 1, the present invention further comprises a left upper platform 23, a right upper platform 24, a left lower platform 25, a right lower platform 26, a left intermediary platform 27, and a right intermediary platform 28. In reference to FIG. 8, the left upper platform 23, the left lower platform 25, and the left intermediary platform 27 are hingedly connected to the left front rail 3. Similarly, the right upper platform 24, the right lower platform 26, and the right intermediary platform 28 are hingedly connected to the right front rail 4. In reference to FIG. 8, the left upper platform 23, the left lower platform 25, and the left intermediary platform 27 are positioned adjacent to a front surface 7 of the left front rail 3. More specifically, the left upper platform 23 is positioned in between the plate 9 and the cross brace assembly 12. The left lower platform 25 is positioned in between the cross brace assembly 12 and the distal end 6 of the left front rail 3. The left intermediary platform 27 is positioned in between the left upper platform 23 and the left lower platform 25. In reference to FIG. 8, the right upper platform 24, the right lower platform 26, and the right intermediary platform 28 are positioned adjacent to a front surface 7 of the right front rail 4. More specifically, the right upper platform 24 is positioned in between the plate 9 and the cross brace assembly 12. The right lower platform 26 is positioned in between the cross brace assembly 12 and the distal end 6 of the right front rail 4. The right intermediary platform 28 is positioned in between the right upper platform 24 and the right lower platform 26. As a result, the user is able to selectively positioned an artwork within the preferred embodiment of the foldable frame 1 utilizing three different height levels. For example, the user can utilize the left upper platform 23 and the right upper platform 24 to attain the highest elevation for an artwork as left upper platform 23 and the right upper platform 24 become the pair of platforms. Similarly, the user can utilize the left lower platform 25 and the right lower platform 26 to attain the lowest elevation for an artwork as left lower platform 25 and the right lower platform 26 become the pair of platforms Likewise, the user can utilize the left intermediary platform 27 and the right intermediary platform 28 to attain the intermediate elevation for an artwork as left intermediary platform 27 and the right intermediary platform 28 become the pair of platforms.

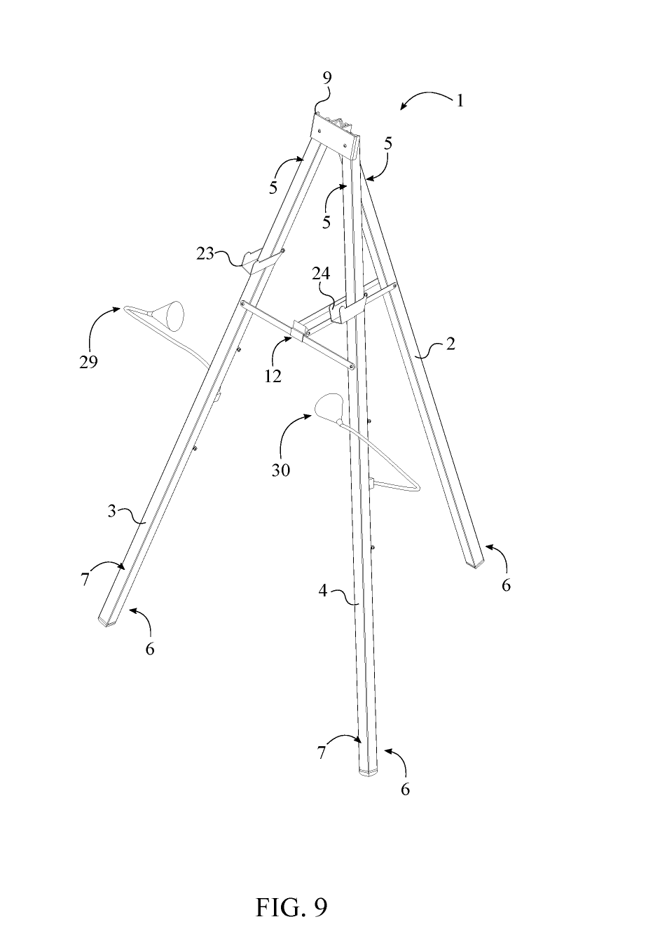

In reference to a first alternative embodiment of the foldable frame 1, the present invention can comprise only the left upper platform 23 and the right upper platform 24. In reference to FIG. 9, the left upper platform 23 is hingedly connected to the left front rail 3. The right upper platform 24 is hingedly connected to the right front rail 4. More specifically, the left upper platform 23 is positioned adjacent to the front surface 7 of the left front rail 3, wherein the left upper platform 23 is positioned in between the plate 9 and the cross brace assembly 12. The right upper platform 24 is positioned adjacent to the front surface 7 of the right front rail 4, wherein the right upper platform 24 is positioned in between the plate 9 and the cross brace assembly 12. Since the left upper platform 23 and the right upper platform 24 are the only pair of platforms within the first alternative embodiment of the foldable frame 1, the user can only utilize the left upper platform 23 and the right upper platform 24 to place an artwork. For example, the first alternative embodiment of the foldable frame 1 is ideal for small sized artworks.

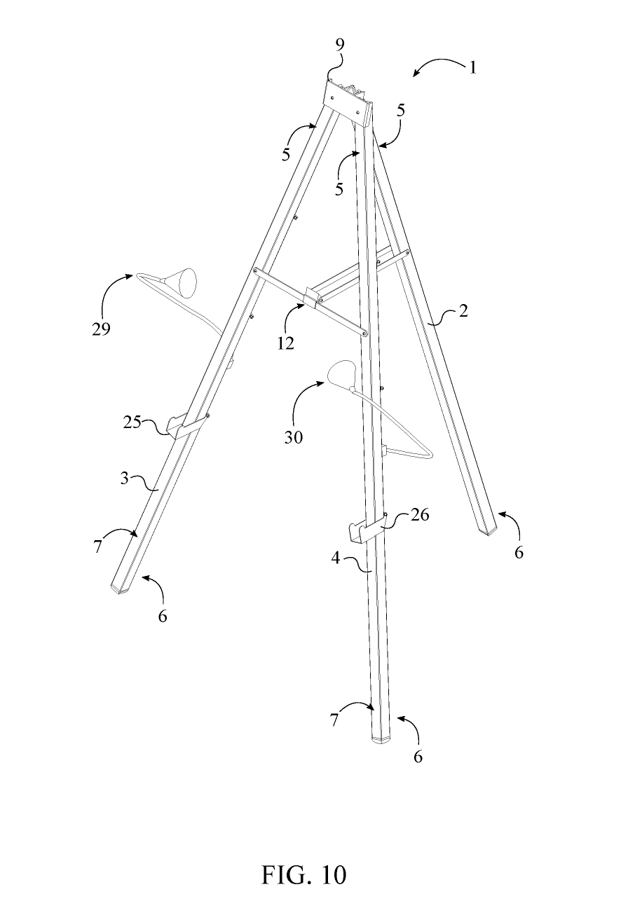

In reference to a second alternative embodiment of the foldable frame 1, the present invention can comprise only the left lower platform 25 and the right lower platform 26. In reference to FIG. 10, the left lower platform 25 is hingedly connected to the left front rail 3. The right lower platform 26 is hingedly connected to the right front rail 4. More specifically, the left lower platform 25 is positioned adjacent to the front surface 7 of the left front rail 3, wherein the left lower platform 25 is positioned in between the cross brace assembly 12 and the distal end 6 of the left front rail 3. The right lower platform 26 is positioned adjacent to the front surface 7 of the right front rail 4, wherein the right lower platform 26 is positioned in between the cross brace assembly 12 and the distal end 6 of the right front rail 4. Since the left lower platform 25 and the right lower platform 26 are the only pair of platforms within the second alternative embodiment of the foldable frame 1, the user can only utilize the left lower platform 25 and the right lower platform 26 to place an artwork. For example, the second alternative embodiment of the foldable frame 1 is ideal for large sized artworks.

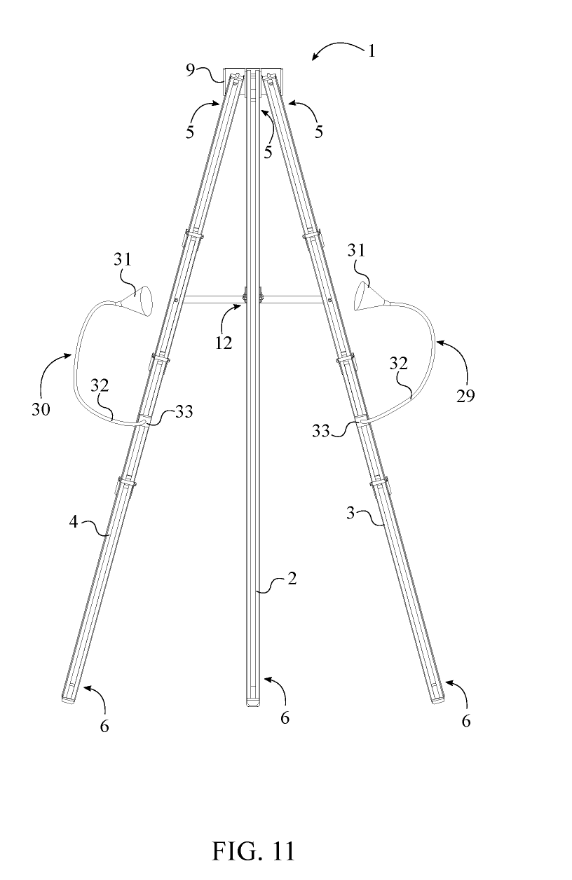

The left light fixture 29 provides illumination to an artwork that is placed within the foldable frame 1 from the left side while the right light fixture 30 provides illumination from the right side. In reference to FIG. 1 and FIG. 11, the left light fixture 29 and the right light fixture 30 each comprise an illuminating device 31, a malleable arm 32, and a track fixture 33. The illuminating device 31, preferably a plurality of light-emitting diodes, is mounted to the track fixture 33 by the malleable arm 32 so that the user is able to redirect the illuminating device 31 as needed. Since the malleable arm 32 maintains the user defined angles and shapes, the left light fixture 29 and the right light fixture 30 can provide a direct lighting beam towards an artwork. The track fixture 33 of the left light fixture 29 is detachably engaged with the left front rail 3. The track fixture 33 of the right light fixture 30 is detachably engaged with the right front rail 4. As a result, the left light fixture 29 is detachably positioned in between the proximal end 5 and the distal end 6 of the left front rail 3 Likewise, the right light fixture 30 is detachably positioned in between the proximal end 5 and the distal end 6 of the right front rail 4. Additionally, the left light fixture 29 and the right light fixture 30 can also function as a slidable lighting system within the present invention when required by the user.

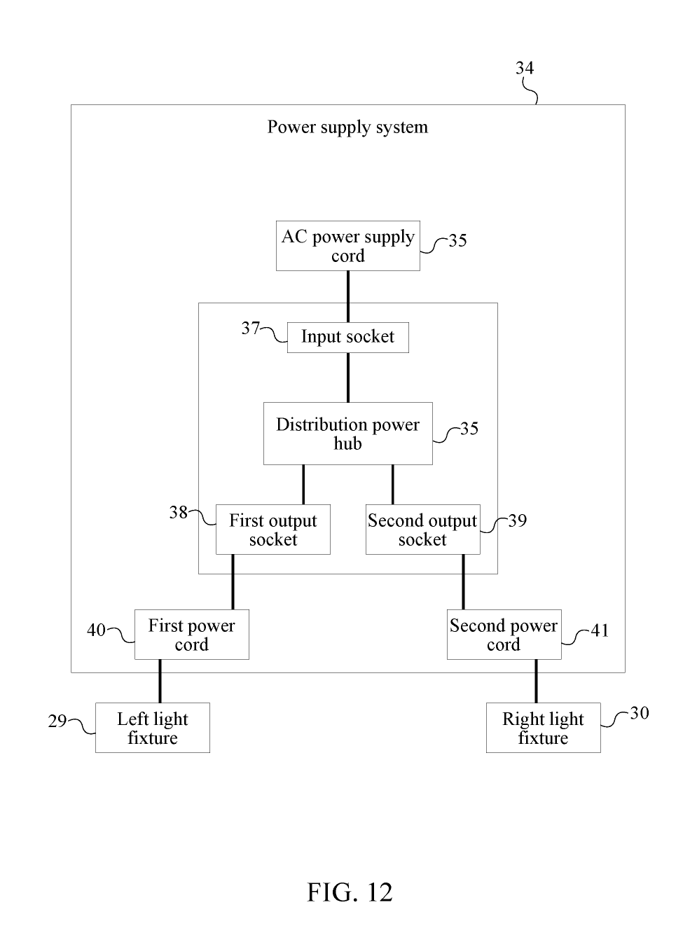

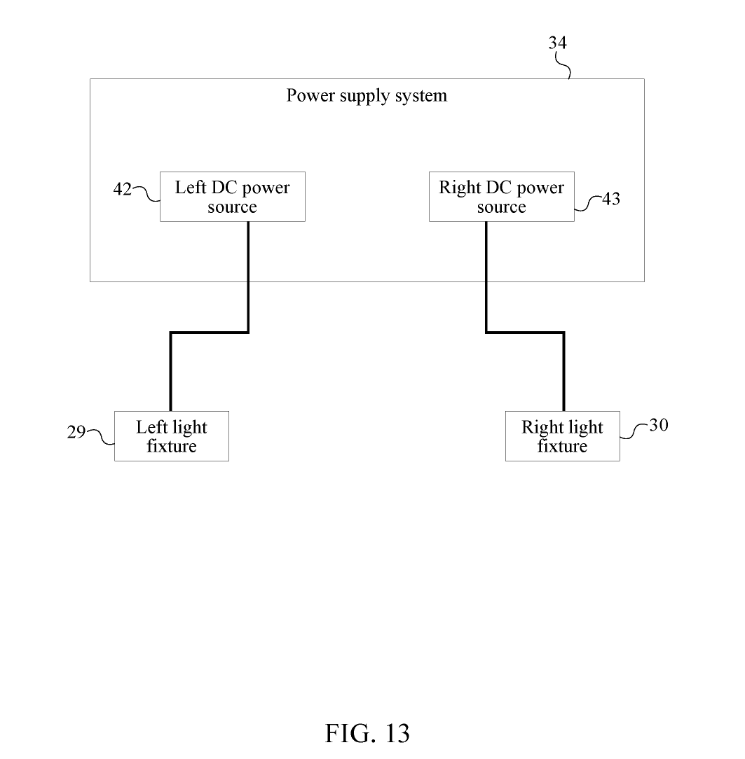

The power supply system 34 powers the left light fixture 29 and the right light fixture 30 within the present invention. Depending upon user preference, the power supply system 34 can be an alternative current (AC) system or a direct current (DC) system. In reference to the AC system that is shown in FIG. 12, the power supply system 34 comprises an AC power supply cord 35, a distribution power hub 36, a first power cable 40, and a second power cable 41. The AC power supply cord 35, the distribution power hub 36, the first power cable 40, the second power cable 41 function as a single electrical apparatus and preferably positioned within rear central rail 2 so that electricity can be supplied to the left light fixture 29 and the right light fixture 30. More specifically, the AC power supply cord 35 is electrically connected to an input socket 37 of the distribution power hub 36 so that the distribution power hub 36 is able receive electricity from an external power source. Additionally, the left light fixture 29 is electrically connected with a first output socket 38 of the distribution power hub 36 by the first power cable 40. Similarly, the right light fixture 30 is electrically connected with a second output socket 39 of the distribution power hub 36 by the second power cable 41. Optionally, the left front rail 3 and the right front rail 4 may each further comprises a pair of integrated electrical tracks that the first power cable 40 and the second power cable 41 electrically connect with. The pair of integrated electrical tracks is internally positioned and extended along left front rail 3 and the right front rail 4. More specifically, the pair of integrated electrical tracks of the left front rail 3 electrically connects with the first power cable 40 about the proximal end 5 of the left front rail 3 so that the left light fixture 29 can be powered through the pair of integrated electrical tracks of the left front rail 3. Similarly, the pair of integrated electrical tracks of the right front rail 4 electrically connects with the second power cable 41 about the proximal end 5 of the right front rail 4 so that the right light fixture 30 can be powered through the pair of integrated electrical tracks of the left front rail 4.

In reference to the DC system that is shown in FIG. 13, the power supply system 34 comprises a left DC power source 42 and a right DC power source 43. More specifically, the left DC power source 42 is internally positioned with the left front rail 3 and electrically connected to the left light fixture 29. Similarly, the right DC power source 43 is internally positioned with the right front rail 4 and electrically connected to the right light fixture 30.

The power supply system 34 can further comprise an on/off switch and a dimmer switch. The on/off switch providing selective control over the left light fixture 29 and/or the right light fixture 30. For example, if the user desires only the left light fixture 29 is required for a specific artwork, the user can activate only the left light fixture 29 through the on/off switch. The dimmer switch allows the user control the brightness of the illuminating device 31 to create the precise lighting effects from the left light fixture 29 and/or the right light fixture 30.

Although the invention has been explained in relation to its preferred embodiment, it is to be understood that many other possible modifications and variations can be made without departing from the spirit and scope of the invention as hereinafter claimed.

What is claimed is:

1. A foldable easel with a lighting system comprises:
a foldable frame;
a power supply system;
a left light fixture;
a right light fixture;
the foldable frame comprises a rear central rail, a left front rail, a right front rail, a plate, and a cross brace assembly;
a proximal end of the rear central rail, the left front rail, and the right front rail each being hingedly connected to the plate;
the cross brace assembly being hingedly connected to the rear central rail, the left front rail, and the right front rail;
the cross brace assembly being positioned in between the plate and a distal end of the rear central rail, the left front rail, and the right front rail;
the left light fixture being detachably mounted to the left front rail;
the right light fixture being detachably mounted to the right front rail; and
the left light fixture and the right light fixture being electrically connected to the power supply system.

2. The foldable easel with a lighting system as claimed in claim 1 comprises:
the proximal end of the left front rail being hingedly mounted to a rear surface of the plate by a left lateral joint;
the proximal end of the right front rail being hingedly mounted to the rear surface of the plate by a right lateral joint;
the proximal end of the rear central rail being hingedly mounted to a pair of perpendicular supports of the plate by a rear joint;
the rear joint being positioned in between the left lateral joint and the right lateral joint;
a rotational axis of the left lateral joint being oriented parallel to a rotational axis of the right lateral joint; and
a rotational axis of the rear joint being oriented perpendicular to the rotational axis of the right lateral joint and the rotational axis of the left lateral joint.

3. The foldable easel with a lighting system as claimed in claim 1 comprises:
the foldable frame a plurality of no-slip foot members; and
each no-slip foot member being adjacently connected to the distal end of the rear central rail, the left front rail, and the right front rail.

4. The foldable easel with a lighting system as claimed in claim 1 comprises:
the cross brace assembly comprises a rear brace, a left front brace, a right front brace, and a mounting hub;
the mounting hub and the left front rail being hingedly mounted to each other by the left front brace;
the mounting hub and the right front rail being hingedly mounted to each other by the right front brace;
the left front brace and the right front brace being oppositely positioned of each other about the mounting hub;
the mounting hub and the rear central rail being hingedly mounted to each other by the rear brace; and
the rear brace being perpendicularly positioned of the left front brace and the right front brace.

5. The foldable easel with a lighting system as claimed in claim 1 comprises:
a left upper platform;
a right upper platform;
the left upper platform being hingedly connected to the left front rail;
the left upper platform being positioned adjacent to a front surface of the left front rail;
the left upper platform being positioned in between the plate and the cross brace assembly;
the right upper platform being hingedly connected to the right front rail;
the right upper platform being positioned adjacent to a front surface of the right front rail; and
the right upper platform being positioned in between the plate and the cross brace assembly.

6. The foldable easel with a lighting system as claimed in claim 1 comprises:
a left lower platform;
a right lower platform;
the left lower platform being hingedly connected to the left front rail;
the left lower platform being positioned adjacent to a front surface of the left front rail;
the left lower platform being positioned in between the cross brace assembly and the distal end of the left front rail;
the right lower platform being hingedly connected to the right front rail;
the right lower platform being positioned adjacent to a front surface of the right front rail; and
the right lower platform being positioned in between the cross brace assembly and the distal end of the right front rail.

7. The foldable easel with a lighting system as claimed in claim 1 comprises:
a left upper platform;
a right upper platform;
a left lower platform;
a right lower platform;
a left intermediary platform;
a right intermediary platform;
the left upper platform, the left lower platform, and the left intermediary platform being hingedly connected to the left front rail;
the left upper platform, the left lower platform, and the left intermediary platform being positioned adjacent to a front surface of the left front rail;
the left upper platform being positioned in between the plate and the cross brace assembly;
the left lower platform being positioned in between the cross brace assembly and the distal end of the left front rail;
the left intermediary platform being positioned in between the left upper platform and the left lower platform;
the right upper platform, the right lower platform, and the right intermediary platform being hingedly connected to the right front rail;
the right upper platform, the right lower platform, and the right intermediary platform being positioned adjacent to a front surface of the right front rail;
the right upper platform being positioned in between the plate and the cross brace assembly;
the right lower platform being positioned in between the cross brace assembly and the distal end of the right front rail; and
the right intermediary platform being positioned in between the right upper platform and the right lower platform.

8. The foldable easel with a lighting system as claimed in claim 1 comprises:
the left light fixture being detachably positioned in between the proximal end and the distal end of the left front rail; and
the right light fixture being detachably positioned in between the proximal end and the distal end of the right front rail.

9. The foldable easel with a lighting system as claimed in claim 1 comprises:
the left light fixture and the right light fixture each comprise an illuminating device, a malleable arm, and a track fixture;
the illuminating device being mounted to the track fixture by the malleable arm;
the track fixture of the left light fixture being detachably engaged with the left front rail; and
the track fixture of the right light fixture being detachably engaged with the right front rail.

10. The foldable easel with a lighting system as claimed in claim 1 comprises:
the power supply system comprises an alternating current (AC) power supply cord, a distribution power hub, a first power cable, and a second power cable;
the distribution power hub comprises an input socket, a first output socket, and a second output socket;
the AC power supply cord being electrically connected to the input socket;
the left light fixture being electrically connected with the first output socket by the first power cable; and
the right light fixture being electrically connected with the second output socket by the second power cable.

11. The foldable easel with a lighting system as claimed in claim 1 comprises:
the power supply system comprises a left direct current (DC) power source and a right DC power source;
the left DC power source being internally positioned with the left front rail;
the left DC power source being electrically connected to the left light fixture;
the right DC power source being internally positioned with the right front rail; and
the right DC power source being electrically connected to the right light fixture.

12. A foldable easel with a lighting system comprises:
a foldable frame;
a power supply system;
a left light fixture;
a right light fixture;
the foldable frame comprises a rear central rail, a left front rail, a right front rail, a plate, a cross brace assembly, and a plurality of no-slip foot members;
a proximal end of the rear central rail, the left front rail, and the right front rail each being hingedly connected to the plate;
the cross brace assembly being hingedly connected to the rear central rail, the left front rail, and the right front rail;
the cross brace assembly being positioned in between the plate and a distal end of the rear central rail, the left front rail, and the right front rail;
the left light fixture being detachably mounted in between the proximal end and the distal end of the left front rail;
the right light fixture being detachably mounted in between the proximal end and the distal end of the right front rail; and
the left light fixture and the right light fixture being electrically connected to the power supply system.

13. The foldable easel with a lighting system as claimed in claim 1 comprises:
the proximal end of the left front rail being hingedly mounted to a rear surface of the plate by a left lateral joint;
the proximal end of the right front rail being hingedly mounted to the rear surface of the plate by a right lateral joint;
the proximal end of the rear central rail being hingedly mounted to a pair of perpendicular supports of the plate by a rear joint;
each no-slip foot member being adjacently connected to the distal end of the rear central rail, the left front rail, and the right front rail;
the rear joint being positioned in between the left lateral joint and the right lateral joint;
a rotational axis of the left lateral joint being oriented parallel to a rotational axis of the right lateral joint; and
a rotational axis of the rear joint being oriented perpendicular to the rotational axis of the right lateral joint and the rotational axis of the left lateral joint.

14. The foldable easel with a lighting system as claimed in claim 1 comprises:
the cross brace assembly comprises a rear brace, a left front brace, a right front brace, and a mounting hub;
the mounting hub and the left front rail being hingedly mounted to each other by the left front brace;
the mounting hub and the right front rail being hingedly mounted to each other by the right front brace;
the left front brace and the right front brace being oppositely positioned of each other about the mounting hub;
the mounting hub and the rear central rail being hingedly mounted to each other by the rear brace; and
the rear brace being perpendicularly positioned of the left front brace and the right front brace.

15. The foldable easel with a lighting system as claimed in claim 1 comprises:
a left upper platform;
a right upper platform;
the left upper platform being hingedly connected to the left front rail;
the left upper platform being positioned adjacent to a front surface of the left front rail;
the left upper platform being positioned in between the plate and the cross brace assembly;
the right upper platform being hingedly connected to the right front rail;
the right upper platform being positioned adjacent to a front surface of the right front rail; and
the right upper platform being positioned in between the plate and the cross brace assembly.

16. The foldable easel with a lighting system as claimed in claim 1 comprises:
a left lower platform;
a right lower platform;
the left lower platform being hingedly connected to the left front rail;
the left lower platform being positioned adjacent to a front surface of the left front rail;
the left lower platform being positioned in between the cross brace assembly and the distal end of the left front rail;
the right lower platform being hingedly connected to the right front rail;
the right lower platform being positioned adjacent to a front surface of the right front rail; and
the right lower platform being positioned in between the cross brace assembly and the distal end of the right front rail.

17. The foldable easel with a lighting system as claimed in claim 1 comprises:
a left upper platform;
a right upper platform;
a left lower platform;
a right lower platform;
a left intermediary platform;
a right intermediary platform;
the left upper platform, the left lower platform, and the left intermediary platform being hingedly connected to the left front rail;
the left upper platform, the left lower platform, and the left intermediary platform being positioned adjacent to a front surface of the left front rail;
the left upper platform being positioned in between the plate and the cross brace assembly;
the left lower platform being positioned in between the cross brace assembly and the distal end of the left front rail;
the left intermediary platform being positioned in between the left upper platform and the left lower platform;
the right upper platform, the right lower platform, and the right intermediary platform being hingedly connected to the right front rail;
the right upper platform, the right lower platform, and the right intermediary platform being positioned adjacent to a front surface of the right front rail;
the right upper platform being positioned in between the plate and the cross brace assembly;
the right lower platform being positioned in between the cross brace assembly and the distal end of the right front rail; and
the right intermediary platform being positioned in between the right upper platform and the right lower platform.

18. The foldable easel with a lighting system as claimed in claim 1 comprises:
the left light fixture and the right light fixture each comprise an illuminating device, a malleable arm, and a track fixture;
the illuminating device being mounted to the track fixture by the malleable arm;
the track fixture of the left light fixture being detachably engaged with the left front rail; and
the track fixture of the right light fixture being detachably engaged with the right front rail.

19. The foldable easel with a lighting system as claimed in claim 1 comprises:
the power supply system comprises an alternating current (AC) power supply cord, a distribution power hub, a first power cable, and a second power cable;
the distribution power hub comprises an input socket, a first output socket, and a second output socket;
the AC power supply cord being electrically connected to the input socket;
the left light fixture being electrically connected with the first output socket by the first power cable; and
the right light fixture being electrically connected with the second output socket by the second power cable.

20. The foldable easel with a lighting system as claimed in claim 1 comprises:
the power supply system comprises a left direct current (DC) power source and a right DC power source;
the left DC power source being internally positioned with the left front rail;
the left DC power source being electrically connected to the left light fixture;
the right DC power source being internally positioned with the right front rail; and
the right DC power source being electrically connected to the right light fixture.
